(19) United States
(12) Patent Application Publication
(10) Pub. No.: US 2006/0236610 A1
(43) Pub. Date: Oct. 26, 2006

(54) Cast hatch with lift assist

(75) Inventor: Herbert Carl Barnum, East Jordan, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: East Jordan Iron Works, Inc.

(21) Appl. No.: 11/112,296

(22) Filed: Apr. 22, 2005

(51) Int. Cl. E05F 11/24

(52) U.S. Cl. 49/339; 49/379

(57) ABSTRACT

A cast hatch having a frame, a hinged cover and a lift assist mechanism. The lift assist mechanism includes a torsion spring with threaded ends. A slide block is threadedly mounted to one threaded end to provide an interface between the spring and the cover. A pressure block is threadedly mounted to the other end to provide an interface between the spring and the frame or support structure. In one embodiment, the lift assist includes two torsion springs. In this embodiment, the two torsion springs may be mounted to a single slide block at one end and mounted to separate pressure blocks at the other end. The pressure blocks may be generally rectangular and include an eccentrically disposed through bore to be fitted over a threaded end of the spring.

### BACKGROUND OF THE INVENTION

The present invention relates to industrial castings and more particularly to spring-assisted lift hatches.

Castings with lift assist hatches are well-known in the industry. These castings typically include a frame that is mounted in a support structure to cover an opening and a cover that is hingedly secured to the frame. In use, the cover can be opened to gain access to the opening. In some applications, the cover must be capable of bearing high loads. For example, these types of castings may be used at airports, parking lot and along streets where they may be required to bear the weight of heavy vehicles. In these types of applications, the hatch is manufactured from relatively heavy cast components. The weight of the cast cover can make it difficult to open and close the hatch.

To address this problem, it is known to provide the casting with lift assist springs that provide a mechanical assist in lifting the cover. In some case, the lift assist springs are torsion springs that are mounted to the frame with one free end engaging the cover and the other free end engaging the structure in which the casting is mounted, for example, a concrete box. In many applications, the lift assist mechanism includes two torsion springs that cooperate in providing assistance. In use, the free ends of the torsion springs typically move with respect to the cover as the cover is opened and closed. Direct sliding engagement between the free end of the torsion springs and the cover can result in damage to the casting and make it difficult to operate the hatch. To provide an improved interface between the torsion springs and the cover, a slide block is typically mounted to the free ends of the torsion springs to engage the cover. These slide blocks ride along surfaces of the cover, for example, within a channel cast into the cover. Also, to distribute the force of the other free end of the torsion springs against the support structure, pressure blocks have been mounted to the free ends of the torsion springs that engage the support structure.

Although lift assist springs make it easier to operate the hatch, conventional lift assist springs suffer disadvantages resulting from the mechanism used to secure the pressure and slide blocks to the torsion springs. Typically, the slide and pressure blocks are secured to the torsion springs by set screws. More specifically, the blocks are fitted over the ends of the torsions springs and then secured in place by a set screw that is tightened through the blocks against the outside surface of the torsion spring. Over time, the blocks have a tendency to become loose and may ultimately fall off of the torsion springs. Once off, the slide blocks may fall into the opening covered by the casting and become lost. Once lost, the lift hatch is typically operated without the block. This can lead to damage to the casting, such as the lift hatch, the frame or the hinge joining the two components. Although it may be possible to reduce the likelihood of this problem by periodically checking and tightening the set screws, this type of maintenance typically does not occur and, even if it were to occur, it would have an undesirable associated cost.

### SUMMARY OF THE INVENTION

The aforementioned problems are overcome by the present invention wherein a hatch is provided with a lift assist mechanism having at least one torsion spring with a threaded free end and a block that is threadedly secured to the threaded free end. The attachment structure of the present invention can be incorporated into slide blocks and pressure blocks by including threads on one or both free ends of the torsion spring.

In one embodiment, the block is fitted over the threaded free end of the torsion spring and secured in place by nuts or other threaded fasteners threaded directly onto the threaded segments of the spring. For example, the block may be sandwiched between a pair of nuts or other threaded fasteners. In an alternative embodiment, the block may define a bore having internal threads so that the block can be threaded directly onto the torsion spring without the need for separate threaded fasteners, such as nuts.

In another embodiment, the lift assist mechanism may include two torsion springs that cooperate in assisting the lifting of the cover. The ends of the two springs that interact with the cover may both be threaded and mounted to a single slide block. Also, the ends of the two springs that interact with the support structure may be threaded and mounted to separate pressure blocks.

In yet another embodiment, the block may include a plurality of flat engagement surfaces and define an eccentric internal bore that is fitted over the free end of the torsion spring. The plurality of engagement surfaces and the eccentric internal bore permit the block to be rotated into different positions to vary the distance between the free end and the bearing surface (such as the lift hatch or the frame), which in turn varies the amount of lift assist provided by the spring. By increasing this distance, the tension in the spring and consequently the amount of assist can be increased. By decreasing this distance, the tension in the spring and consequently the amount of assist can be decreased.

The present invention provides a simple and effective mechanism for securing slide and pressure blocks to the torsion springs. The threaded connection between the blocks and the torsion springs is easy to operate, secure and is far less likely to become loose over time than the set screw attachment of conventional systems The threaded connection does not require a high torque attachment, thereby facilitating installation. Further, the position of the blocks on the ends of the torsion springs can be easily adjusted to vary the tension in the spring and consequently the amount of assist simply by adjusting the location of the threaded fastener(s). In applications where the block includes an eccentric bore, the tension in a spring can be easily adjusted simply by rotating the block about the free end of the spring.

These and other objects, advantages, and features of the invention will be readily understood and appreciated by reference to the detailed description of the preferred embodiment and the drawings.

### BRIEF DESCRIPTION OF THE DRAWINGS

FIG. 1A is a perspective view of a hatch in accordance with an embodiment of the present invention.

FIG. 1B is an enlarged perspective view of Area 1B of FIG. 1A.

FIG. 2A is a top plan view of the hatch with the cover open.

FIG. 2B is a sectional view of the hatch taken along line 2B-2B of FIG. 2A.

FIG. 3A is a front elevational view of the hatch with the cover open.

FIG. 3B is a sectional view of the hatch taken along line 3B-3B of FIG. 3A.

FIG. 3C is an enlarged perspective view of Area 3C of FIG. 3B.

FIG. 4 is a top plan view of the hatch with the cover closed.

FIG. 5 is a top plan view of the frame.

FIG. 6A is a sectional view of the cover taken along line 6A-6A of FIG. 4

FIG. 6B is a sectional view of the cover taken along line 6B-6B of FIG. 4

FIG. 7 is a top plan view of the right torsion spring.

FIG. 8A is a top plan view of the slide block.

FIG. 8B is a side elevational view of the slide block.

FIG. 9A is a top plan view of the pressure block.

FIG. 9B is a side elevational view of the pressure block.

### DETAILED DESCRIPTION OF THE PREFERRED EMBODIMENT

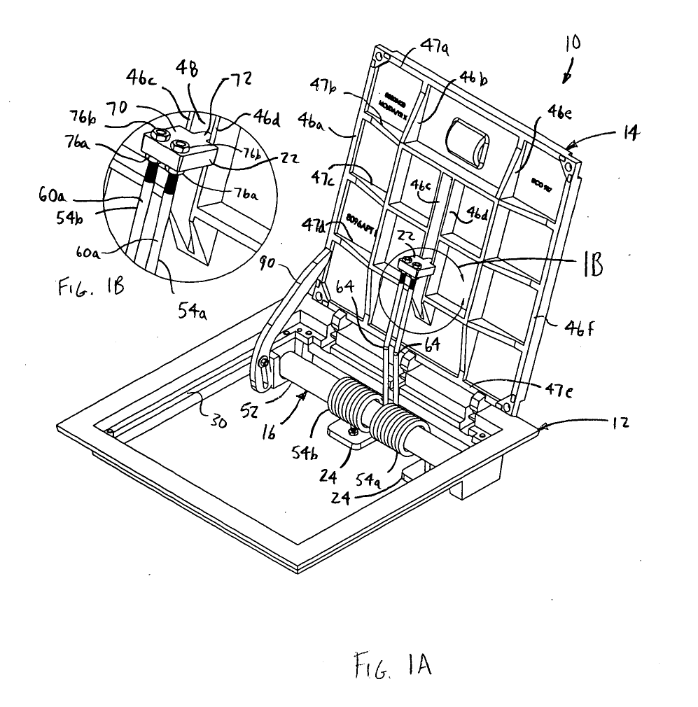

A lift hatch casting in accordance with an embodiment of the present invention is shown in FIG. 1A and generally designated 10. The hatch 10 generally includes a frame 12, a cover 14 and a lift assist mechanism 16. The frame 12 may be fixed in a support structure (not shown) over an opening, such as a manhole (not shown). The cover 14 is hinged to the frame 12 so that the cover can be swung open to provide access to the opening beneath the hatch 10. The lift assist mechanism 16 includes lift-assist torsion springs 54a and 54b positioned between the frame 12 (or the support structure in which the frame 12 is mounted) and the cover to assist in lifting the cover 14. A slide block 22 is mounted to the free ends of the torsion springs 54a-b to provide and interface between the springs 54a-b and the cover 14. The free ends of the torsion springs 54a-b are threaded to receive structure for threadedly securing the slide block 22 to the springs 54a-b. Pressure blocks 24a-b may be mounted to the opposite free ends of the springs 54a-b to provide an interface between the springs 54a-b and the frame 12 or the structure in which the frame is mounted. The present invention is described in connection with a generally square lift hatch having a lift assist mechanism with dual torsion springs. The present invention is not, however, limited to any specific hatch construction or lift assist mechanism.

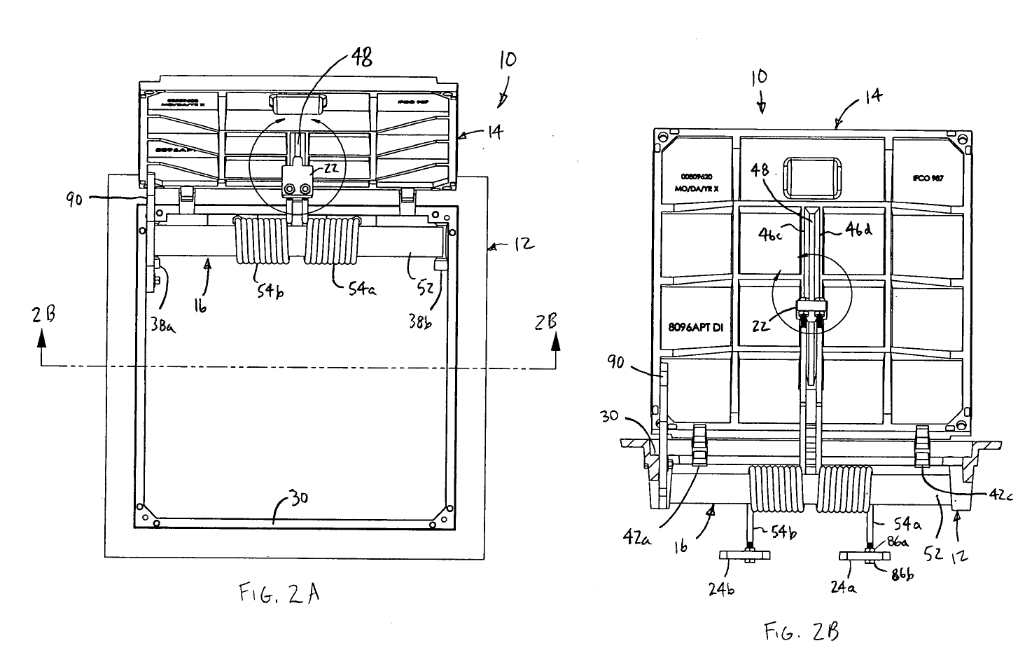

As noted above, the hatch 10 includes a frame 12 intended to be mounted to a support structure over an underlying hole, such as a manhole. The frame 12 is a generally conventional lift assist hatch frame. Referring to FIGS. 5, 2B and 3B, the frame 12 of this embodiment is generally square including a plurality of side wall segments that cooperatively define a square opening. The frame 12 includes an annular shoulder 30 that extends substantially around the opening to form a shelf to receive the cover 14, as described in more detail below. The frame 12 defines three hinge pockets 32a-c to receive the hinges 42a-c of the cover 14. The number of hinge pockets 32 may vary from application to application as desired. The frame 12 may also include generally conventional hinge pins 34a-c that are disposed it the hinge pockets 32a-c to provide a hinge point for the cover 14. The frame 12 may further define a pair of mounting pipe hangers 38a-b. The mounting pipe hangers 38a-b are disposed on opposite side wall segments and are adapted to receive opposite ends of the mounting pipe 52 to support the lift assist mechanism 16, as described in more detail below. The frame 12 of this embodiment is cast from gray iron, but may alternatively be manufactured from other conventional materials.

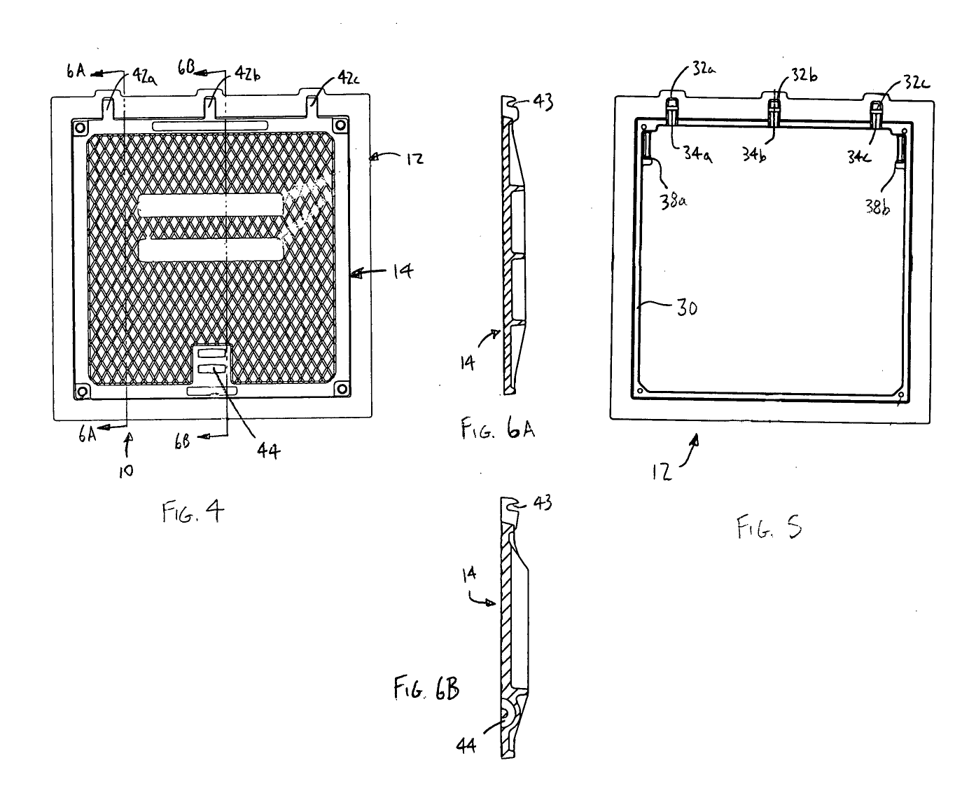

The cover 14 is a generally conventional hatch cover. The cover 14 is configured to be operatively interfitted with the frame 12. In this embodiment, the cover 14 is generally square and is designed to be fitted into the space defined by should 30 (See FIGS. 4, 6A and 6B). The cover 14 includes three hinges 42a-c, but the number of hinges may vary from application to application as desired. Each hinge 42a-c defines a mouth 43 configured to be fitted over the corresponding hinge pin 34a-c. In operation, as the cover 14 is lifted, the hinges 42a-c pivot about the hinge pins 34a-c. The cover 14 may also define a handle 44 to assist in lifting the cover 14. As perhaps best shown in FIG. 1A, the undersurface of the cover 14 includes a plurality of support ribs 46a-f and 47a-d. The central support ribs 46c and 46d may be configured to define a channel 48 to receive the slide block 22, as shown in FIG. 1B and described in more detail below.

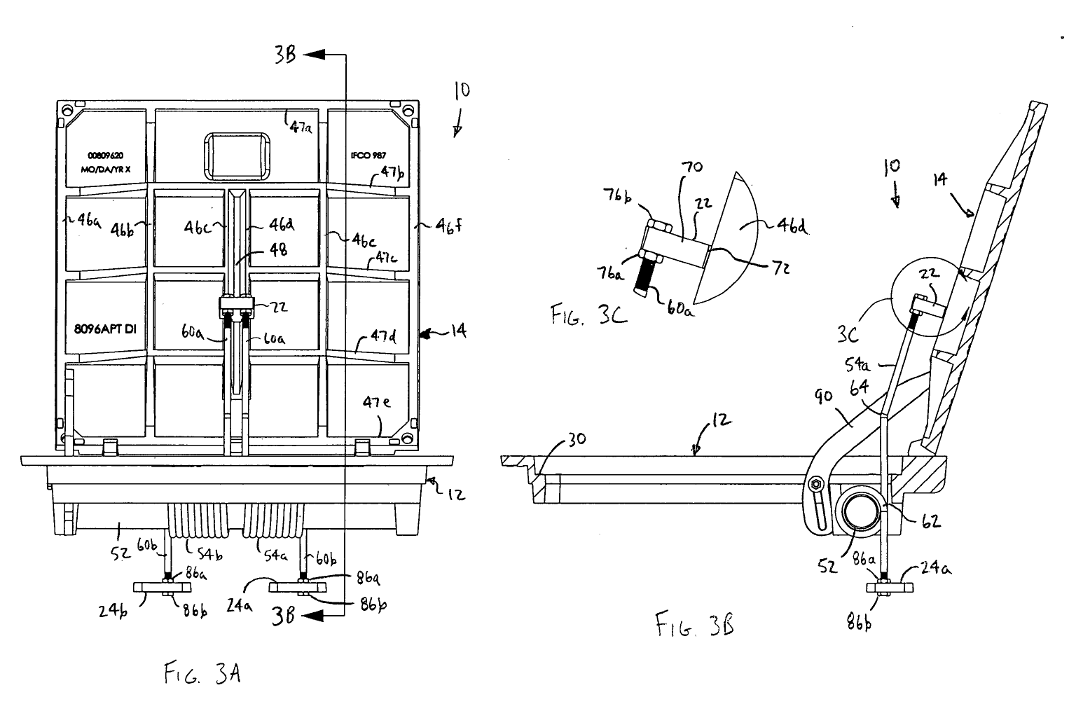

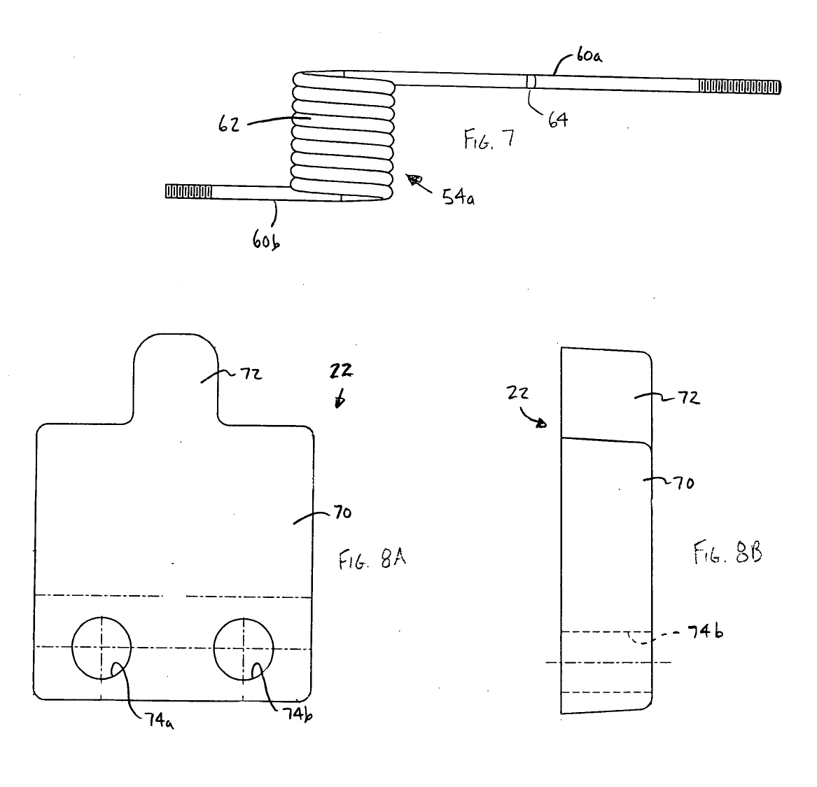

The lift assist mechanism 16 generally includes a mounting pipe 52, a pair of torsion springs 54a-b, a slide block 22 and a pair of pressure blocks 24a-b. The mounting pipe 52 provides a mounting structure for the lift assist mechanism 16. As perhaps best shown in FIG. 1, the mounting pipe 52 is a segment of pipe of other similar material of a length appropriate to fit within and extend between the mounting pipe hangers of the frame 12. In the illustrated embodiment, the lift assist mechanism 16 includes a left-hand torsion spring 54a and a right-hand torsion spring 54b. Each of the torsion springs 54a-b includes a coil 62 and a pair of free ends 60a-b that extend out from the coil 62. The right hand torsion spring 54a is shown in FIG. 7. The left hand torsion spring 54b is essentially a mirror-image of right hand torsion spring 54a. The characteristics of the torsion springs 54a-b are selected to provide the desired level of lift assist. For example, heavier springs may be provided to give greater assist. The coil 62 is configured to be fitted over the mounting pipe 52 to secure the springs in the desired location (See FIGS. 1A and 3B). A close fit between the coil 62 and the pipe 52 may be desirable as it may help to keep the springs 54a-b in alignment. One free end 60a is substantially longer than the other and is intended to interact with the cover 14. The cover free end 60a may include an angle 64 intended to allow the spring to follow the profile of the hatch 10 when the cover 14 is open (See FIGS. 1A and 3B). The shorter free end 60b extends from the coil 62 in a substantially opposite direction from the cover free end 60a and is intended to interact with the support structure (not shown). The free ends 60a and 60b of each spring are threaded. The length of the threaded portion may vary from application to application. The springs 54a-b may be manufactured from conventional materials, such as heat treated stainless steel spring wire or hot rolled steel.

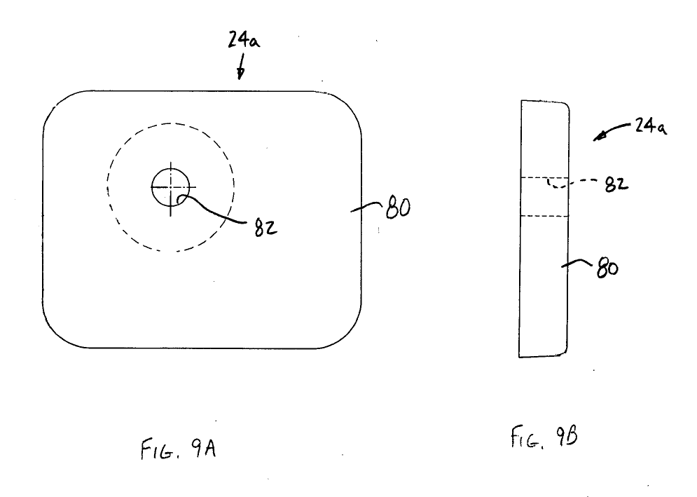

As noted above, the lift assist mechanism 16 also includes slide block 22 that provides an interface between the cover and the springs 54a-b. In this embodiment, the slide block 22 includes a main body 70 and a finger 72 (See FIGS. 8A and 8B). The main body 70 is roughly square and defines a pair of through bores 74a-b. The through bores 74a-b are spaced apart and are of appropriate diameter to receive the cover free end 60a of the springs 54a-b. The finger 72 extends from the main body 70 and is configured to be interfitted with the channel 48 on the undersurface of the cover 14, as shown in FIG. 1B. The channel 48 is configured to shepherd movement of the slide block 22 as the cover 14 is opened and closed. The slide block 22 is installed on the cover ends 60a of the springs 54a-b using a pair of jam nuts 76a-b and, if desired, washers (not shown). More specifically, the first jam nut 76a is threaded onto the cover end 60a, the slide block 22 is then fitted over the cover end 60a and finally the remaining jam nut 76b is threaded onto the cover end 60a. The jam nut 76b is may be tightened against the remaining elements to lock them all in place. The position of the slide bock 22 along the cover ends 60a can be easily adjusted simply by threading the jam nuts 76a-b to different locations along the cover ends 60a. The slide block 22 may be manufactured from conventional materials, for example, ductile iron.

As discussed above, the structure end 60b of each spring 54a-b is intended to engage the support structure in which the hatch 10 is mounted. This may be a concrete box or other similar structure. A pressure block 24a-b may be mounted to each structure end 60b to provide an interface between the springs 54a-b and the support structure. In the illustrated embodiment, a separate pressure block 24a-b is mounted to each structure end 60b. The pressure blocks 24a-b are generally identical and therefore only one will be described. Referring now to FIGS. 9A and 9B, the pressure block 24a includes a generally rectangular body 80 defining a through bore 82. The size of the body 80 may be selected to distribute the force of the corresponding spring 54a-b over an appropriate surface area to avoid damage to the support structure. The through bore 82 may be eccentric with it position selected so that there is a different distance between the bore 82 and each edge of body 80. The eccentric bore 82 permits the tension of the spring 54a-b to be adjusted simply by rotating the pressure block 24a about the spring 54a-b. For example, in the illustrated embodiment, the body 80 is approximately 4 inches by 5 inches and the through bore 82 is centered approximately 1.5 inches from the longer side and 2 inches from the shorter side. Accordingly, the pressure block 24a can be rotated to selectively vary the distance of the support end 60b from the structure between 1.5 inches, 2 inches, 2.5 inches and 3 inches. As a result, a simple rotation of the pressure block 24a can permit easy adjustment between four different spring tensions. The pressure blocks 24a-b are installed on the structure ends 60b of the springs 54a-b using a pair of jam nuts 86a-b and, if desired, washers (not shown) in essentially the same manner as the slide block 22 is secure to the cover ends 60a. As with the slide block 22, the position of the pressure blocks 24a-b along the structure ends 60b can be easily adjusted simply by threading the jam nuts 86a-b to different locations along the structure ends 60b. The pressure blocks 24a-b may be manufactured from conventional materials, for example, gray cast iron.

As can be seen, the threading of the spring ends 60a-b allows the slide block 22 and pressure blocks 24a-b to be securely and easily secured to the springs 54a-b. Although the illustrated embodiment discloses the use of jam nuts for securing the blocks 22 and 24a-b onto the threaded sections of the springs 54a-b, other threaded fastening configurations can be used. For example, if desired, the bores in the slide block and/or pressure blocks may be threaded so that the block can themselves be threaded onto the spring ends 60a-b. In this embodiment, a single jam nut may be used to lock the threaded block in the desired position.

The hatch 10 may also include a generally conventional safety bar 90 that can be manually swung up to secure the cover 14 in the open position and manually swung down to permit the cover 14 to be closed again. The safety bar 90 and its attachment structure are generally conventional and therefore will not be described in detail in this application.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A lift assist hatch comprising:
a frame;
a cover hingedly secured to said frame;
a torsion spring extending between said frame and said cover, said torsion spring including a first free end operatively interacting with said cover, said first free end including a threaded segment; and
a slide block interposed between said first free end and said cover, said slide block threadedly mounted to said threaded segment of said first free end.

2. The lift assist hatch of claim 1 wherein said slide block is threadedly mounted to said threaded segment of said first free end by a pair of nuts disposed on said threaded segment on opposite sides of said slide block.

3. The lift assist hatch of claim 1 wherein said slide block defines an internal bore fitted over said threaded segment of said first free end.

4. The lift assist hatch of claim 3 wherein said internal bore is threaded.

5. The lift assist hatch of claim 2 wherein said torsion spring includes a second free end, said second free end including a threaded segment; and
further including a pressure block threadedly mounted to said threaded segment of said second free end.

6. The lift assist hatch of claim 5 wherein said pressure block defines an eccentric bore fitted over said threaded segment of said second free end.

7. The lift assist hatch of claim 6 wherein said pressure block is threadedly mounted to said threaded segment of said second free end by a pair of nuts disposed on said threaded segment of said second free end on opposite sides of said pressure block.

8. The lift assist hatch of claim 7 further including a second torsion spring and a second pressure block, said second torsion spring include a first free end secured to said slide block and a second free end secured to said second pressure block.

9. A lift assist mechanism for a lift assist hatch having a cover and a frame mounted in a support structure comprising:
a mounting mechanism for mounting to at least one of the frame and the cover;
a torsion spring mounted to said mounting mechanism, said torsion spring including a first free end having a threaded segment; and
a block threadedly mounted to said threaded segment of said torsion spring, said block defining a through bore fitted over said threaded segment, said block positioned to provide an interface between said first free end and at least one of said cover, said frame and said support structure.

10. The lift assist mechanism of claim 9 further including a pair of nuts, said nuts threaded to said threaded segment on opposite sides of said block to threadedly secure said block on said first free end.

11. The lift assist mechanism of claim 9 wherein said through bore is internally threaded and said block is directly threaded onto said threaded segment.

12. The lift assist mechanism of claim 9 wherein said torsion spring includes a second free end and a second block, said second free end having a threaded segment said second block being threadedly secured to said second free end, said second block defining a through bore fitted over said threaded segment of said second free end, said second block positioned to provide an interface between said second free end and at least one of said cover, said frame and said support structure.

13. The lift assist mechanism of claim 12 wherein said second block is rectangular and said through bore of said second block is eccentrically disposed within said second block.

14. An industrial casting comprising:
a cast frame adapted to be mounted within a support structure;
a cast cover hingedly mounted to said frame;
a lift assist mechanism mounted to at least one of said frame and said cover, said lift assist mechanism including at least one torsion spring having a first free end operatively interfacing with said cover and a second free end operatively interfacing with at least one of said frame and the support structure, at least one of said first free end and said second free end includes a threaded segment, said lift assist mechanism further including at least one block threadedly mounted to said threaded segment.

15. The casting of claim 14 wherein said block is threadedly mounted to said threaded segment by a pair nuts directly threaded onto said threaded segment on opposite sides of said block.

16. The casting of claim 15 wherein said block is further defined as a slide block, said slide block being mounted to said first free end interposed between said first free end and said cover.

17. The casting of claim 16 wherein said lift assist mechanism includes a second torsion spring, said second torsion spring having a first free end operatively interfacing with said cover and a second free end operatively interfacing with at least one of said frame and the support structure, at least one of said first free end of said second torsion spring includes a threaded segment, said lift assist mechanism further including a second block threadedly mounted to said threaded segment of said first free end of said second torsion spring.

18. The casting of claim 15 wherein said block is further defined as a pressure block, said pressure block being mounted to said second free end interposed between said second free end and said cover.

19. The casting of claim 18 wherein said pressure block defines an through bore fitted over said second free end, said pressure block being rectangular and defining a through bore eccentrically disposed within said pressure block.

20. The casting of claim 14 wherein each of said free ends of said first torsion spring include a threaded segment; said lift assist mechanism further including a second torsion spring, said second torsion spring having a first free end operatively interfacing with said cover and a second free end operatively interfacing with at least one of said frame and the support structure, each of said free ends of said second torsion spring including a threaded segment, said block further defined as a slide block, said slide block being threadedly mounted to said first free end of said first torsion spring and said first free end of said second torsion spring, said slide block interposed between said first torsion spring and said second torsion spring and said cover; said lift assist mechanism further including first and second pressure blocks, said first pressure block threadedly mounted to said threaded segment of said second free end of said first torsion spring, said second pressure block threadedly mounted to said threaded segment of said second torsion spring.
